(19) United States
(12) Patent Application Publication
(10) Pub. No.: US 2005/0027481 A1
(43) Pub. Date: Feb. 3, 2005

(54) System for making semiconductor devices and processing control thereof

(75) Inventors: Hee-jeon Yang, Kunpo-si (KR); Moon-hyeong Han, Seoul City (KR); Hae-yong Jung, Suwon city (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/823,610

(22) Filed: Apr. 14, 2004

(30) Foreign Application Priority Data
Jul. 18, 2003 (KR) 2003-49308

(51) Int. Cl. G06F 11/30

(52) U.S. Cl. 702/183

(57) ABSTRACT

A process control method managing a semiconductor device manufacturing process, including an operation of a system with a plurality of sub-modules, including diagnosing an operational state of the plurality of sub-modules prior to beginning the semiconductor device manufacturing process, checking a process condition of the system, and informing operational states of the sub-modules and the process condition of the system to a user. With this configuration, a system for making semiconductor devices and processing control thereof prevents a malfunction of the semiconductor device manufacturing system according to a diagnosis of the semiconductor device manufacturing system prior to starting a semiconductor manufacturing process, thereby increasing yield in manufacturing semiconductor devices.

### CROSS-REFERENCE TO RELATED APPLICATIONS

This application claims the benefit of Korean Patent Application No. 2003-49308, filed Jul. 18, 2003 in the Korean Intellectual Property Office, the disclosure of which is incorporated herein by reference.

### BACKGROUND OF THE INVENTION

1. Field of the Invention

The present invention relates to a system for making semiconductor devices and process control thereof, and in more detail, a system for making semiconductor devices and process control thereof, including diagnosing an overall manufacturing process of semiconductor devices prior to a starting of the process control.

2. Description of the Related Art

A process of manufacturing a plurality of semiconductor devices on a wafer generally goes through about 200 singular processes. If a certain system malfunctions during one of the processes, the wafer cannot be used and the whole process has to be stopped to diagnose where, or how, the malfunction occurred.

FIG. 1 is a block diagram of a conventional system for diagnosing a malfunction in a manufacturing process of semiconductor devices.

As illustrated in FIG. 1, a process diagnosing system may include a diagnosis object select part 101, a detail diagnosis select part 102, a diagnosis system select part 103, and a diagnosis result display 104.

In the diagnosis object select part 101, a user can select components of a process equipment to be diagnosed, while the detail diagnosis select part 102 lets the user select a detail of diagnosis items for the process equipment selected in the diagnosis object select part 101.

The diagnosis system select part 103 allows the user to select at least one piece of the diagnosis equipment provided in a semiconductor device manufacturing system to test the detail diagnosis items selected in the detail diagnosis select part 102, and performs the diagnosis of the selected process equipment in detail.

The diagnosis result display 104 displays a diagnosis result of the diagnosis system selected in the diagnosis system select part 103.

In this conventional system, the user selects the process equipment to be diagnosed and the detail of the diagnosis items, depending on an equipment malfunction symptom in the semiconductor manufacturing process, and selects the diagnosis system provided in the semiconductor device manufacturing system to test components of the process equipment corresponding to the malfunction symptom.

The selected diagnosis system tests a performance of the component of the selected process equipment, and outputs the result to the diagnosis result display 104.

However, the conventional diagnosis system is designed for the user to select a diagnosis item and diagnosis equipment depending on an equipment malfunctioning symptom, so as to determine whether that piece of equipment is the cause of the semiconductor device manufacturing system being out of order. Thus, it is time-consuming as an equipment operator has to manually control a controller of the malfunctioning equipment to diagnose and identify the malfunction and/or malfunctioning equipment.

Therefore, if the diagnosis system of the semiconductor manufacturing process can diagnose, i.e., predict, operation states of the semiconductor device manufacturing system before the manufacturing system shows the malfunctioning symptom, it can prevent a malfunction in the semiconductor manufacturing process, thereby increasing yield of manufacturing semiconductor devices.

### SUMMARY OF THE INVENTION

Accordingly, it is an aspect of the present invention to provide a system for making semiconductor devices and processing control thereof to prevent a malfunction of a semiconductor device manufacturing system according to a diagnosis of the semiconductor device manufacturing system prior to starting a semiconductor manufacturing process, thereby increasing yield in manufacturing semiconductor devices.

Additional aspects and/or advantages of the invention will be set forth in part in the description which follows and, in part, will be obvious from the description, or may be learned by practice of the invention.

To accomplish the above and/or other aspects and advantages, embodiments of the present invention provide a process control method managing a semiconductor device manufacturing process, including an operation of a system with a plurality of sub-modules, including diagnosing an operational state of a plurality of sub-modules prior to beginning the semiconductor device manufacturing process, checking a process condition of the system, and informing a user of operational states of the sub-modules and the process condition of the system.

The process control method may further include diagnosing an operational state of I/O (input/output) devices of the sub-modules prior to beginning the semiconductor device manufacturing process, and informing the user of the operational state of the input/output devices of the sub-modules.

The process control method may further include checking whether the operational states of the sub-modules and the process condition are normal by comparing a predetermined normal operation value range with a value estimated from a result-of diagnoses of the sub-modules.

The testing of the sub-modules may include diagnosing a performance condition of equipment based upon at least one of sampled voltage, currents, torques and operational speeds related to the equipment, wherein the equipment may include system components, including various chambers, a conveyor, and a furnace, and parts of system components, including a valve, a pump, a controller, and a roller, in the semiconductor device manufacturing process.

To accomplish the above and/or other aspects and advantages, embodiments of the present invention provide a system for making a semiconductor devices by managing a semiconductor device manufacturing process, including an operation of a system having a plurality of sub-modules, including a module checking part diagnosing an operational state of at least one sub-module of the plural sub-modules, a process condition checking part diagnosing a process condition of the system, a result display displaying a diagnosis result of an object, of a plurality of objects of the system, to be diagnosed, and a controller controlling the module checking part and the process condition checking part to check the operational state of the one sub-module and the process condition of the system prior to beginning the semiconductor device manufacturing process and controlling the display of the result of the diagnosis in the result display.

The system for making a semiconductor device may further include an interface checking part checking an operational state of an I/O device of the one sub-module, wherein the controller controls the result display to display the result of diagnosis performed by the interface checking part.

To accomplish the above and/or other aspects and advantages, embodiments of the present invention provide a computer-readable medium comprising computer readable code controlling a system to perform any of the above methods.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a block diagram of a conventional system for diagnosing of a semiconductor device manufacturing process;

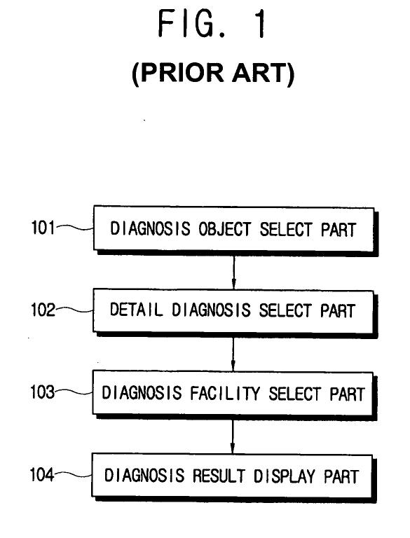

FIG. 2 is a block diagram of a system for making semiconductor devices, according to an embodiment of the present invention; and

FIG. 3 is a flow chart of a process control method, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

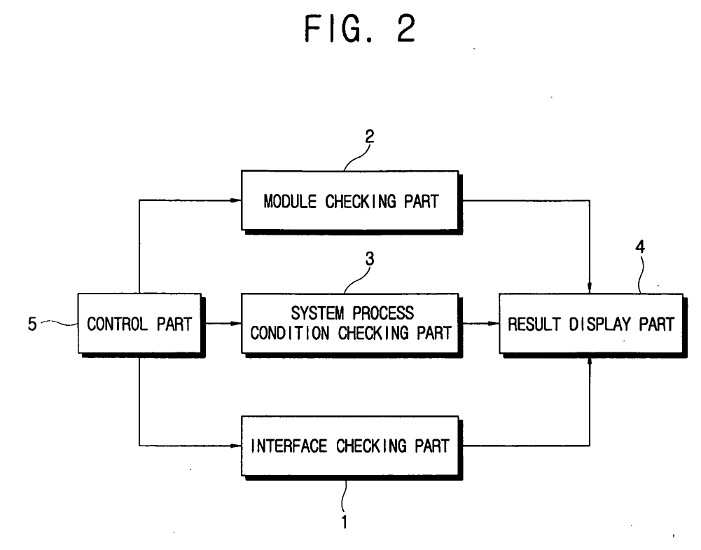

FIG. 2 is a block diagram of a system for making semiconductor device, according to an embodiment of the present invention.

As illustrated in FIG. 2, a semiconductor device manufacturing system with a diagnosis system includes an interface checking part 1, a module checking part 2, a system process condition checking part 3, a result display 4, and a controller 5.

The interface checking part 1 diagnoses states of an I/O (input/output) device and an alarm of each component of process equipment, which is to be diagnosed for potential malfunctions.

The module checking part 2 diagnoses process equipment components which may cause malfunctions, with the process equipment components including system components such as various chambers, a conveyor, a furnace and the like, and parts of the system components such as a valve, a pump, a controller, and a roller in the semiconductor device manufacturing process, etc.

For example, the system process condition checking part 3 diagnoses a pressure and a vacuum condition required for a normal operation of the process equipment components so as to evaluate an overall system performance, thereby evaluating a target, i.e., expected or desired, manufacturing potential.

The result display 4 displays results of the interface checking part 1, the module checking part 2, and the system process condition checking part 3, so an equipment operator can monitor the results. The result display 4 can be implemented as a central control monitor to enable a central command to examine and control each piece of the process equipment, as a whole.

The controller 5 controls the interface checking part 1, the module checking part 2, and the system process condition checking part 3, to perform a diagnosis process in a predetermined proper order, and outputs the result of the diagnosis process to the result display 4, prior to beginning a semiconductor device manufacturing process. In addition, a user may be allowed to select which system element to diagnose in the controller 5.

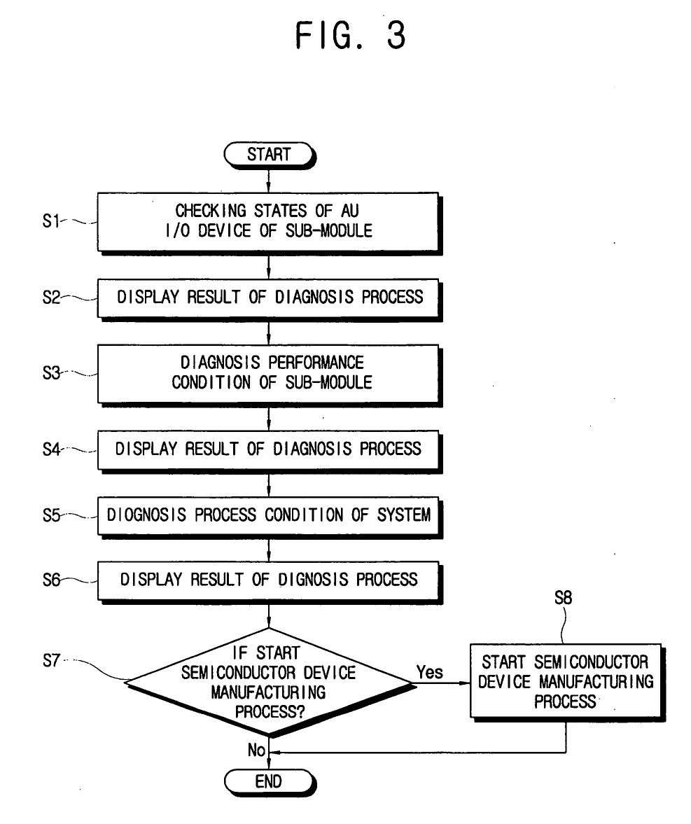

FIG. 3 illustrates a flow chart for a process diagnosis method, according to an embodiment of the present invention.

Thus, referring to FIG. 2 and FIG. 3, an embodiment of the present invention will be described hereafter.

The equipment operator can start diagnosing a system by use of the controller 5 to check overall operational states of the system prior to beginning a semiconductor device manufacturing process.

Once the diagnosis process is initiated, the interface checking part 1 checks operational states of an I/O device of each sub-module, as an object of the diagnosis process at operation Si. The result of the diagnosis process is displayed in the result display 4, with the equipment operator being informed in real time, at operation S2.

If the I/O device operational states of a sub-module are normal, its performance condition is checked at operation S3, with the equipment operator being informed of the result through the result display 4, at operation S4. Testing of the sub-module includes diagnosing the performance condition of the process equipment, which can be implemented in various ways, such as checking voltages, currents, torques, and operation speeds, for example. A diagnosis program module is implemented to operate the sub-module, and the sub-module is diagnosed by the operation of the diagnosis program module. The controller 5 controls the operational states of each sub-module to be diagnosed, in a predetermined order.

If each of the process equipment is operating within proper parameters, the system process condition checking part 3 checks a process condition of the system, at operation S5, and the result is displayed to the system operator in the result display 4 in real time, at operation S6. The system process condition checking part 3 evaluates a general performance of the system, including a vacuum condition of a chamber, a partial pressure rate of gas, etc., and the controller 5 controls the evaluation of the system process condition checking part 3 to proceed in a proper order. A performance evaluation program module is implemented to get the performance of the system, and the condition of the performance of the system process is tested by the operation of the performance evaluation program module.

The result display 4 displays whether the operational state of the sub-module, the process condition, and the I/O device of the sub-module are performing normally based on predetermined normal operating value ranges and values estimated from the result of the diagnosis process.

The equipment operator can determine whether to begin a semiconductor device manufacturing process, based on the result of the diagnosis process, at operation S7, and allow the semiconductor device manufacturing process to proceed, at operation S8.

In addition, a user is permitted to selectively choose what to diagnose, thereby providing flexibility in the diagnosis system by allowing some diagnoses to be skipped.

Similar to the above, embodiments of the present invention may be implemented using computer-readable media including computer readable code controlling a computer, or computers, to implement the aforementioned methods.

Therefore, embodiments of the present invention prevent a malfunction in a semiconductor manufacturing system and provide a central control system with less requirements of separate component control a system operator, thereby increasing yield in manufacturing semiconductor devices.

Although a few embodiments of the present invention have been shown and described, it would be appreciated by those skilled in the art that changes may be made in this embodiment without departing from the principles and spirit of the invention, the scope of which is defined in the claims and their equivalents.

1. A process control method managing a semiconductor device manufacturing process, including an operation of a system with a plurality of sub-modules, comprising:
diagnosing an operational state of the plurality of sub-modules prior to beginning the semiconductor device manufacturing process;
checking a process condition of the system; and
informing a user of operational states of the sub-modules and the process condition of the system.

2. The process control method according to claim 1, further comprising:
diagnosing an operational state of I/O (input/output) devices of the sub-modules prior to beginning the semiconductor device manufacturing process; and
informing the user of the operational state of the input/output devices of the sub-modules.

3. The process control method according to claim 1, wherein the diagnosing of the operational state of the plurality of sub-modules includes operating a diagnosis program module to operate a sub-module to perform a diagnosis program.

4. The process control method according to claim 1, wherein the checking the process condition of the system includes operating a performance diagnosis program module, to check a performance of the system, to perform the performance diagnosis program.

5. The process control method according to claim 1, further comprising checking whether the operational states of the sub-modules and the process condition are normal by comparing a predetermined normal operation value range with a value estimated from a result of the diagnoses of the sub-modules.

6. The process control method according to claim 1, further comprising selecting, by a user, which object or objects of a plurality of objects are to be diagnosed, prior to beginning the semiconductor device manufacturing process.

7. The process control method according to claim 1, wherein the diagnosing of the sub-modules includes diagnosing a performance condition of equipment based upon at least one of sampled voltage, currents, torques and operational speeds related to the equipment.

8. The process control method according to claim 7, wherein the equipment comprises system components, including various chambers, a conveyor, and a furnace, and parts of system components, including a valve, a pump, a controller, and a roller, in the semiconductor device manufacturing process.

9. The process control method according to claim 1, wherein the diagnosing of the operational state of the plurality of sub-modules includes selectively diagnosing some but not all of the plurality of sub-modules.

10. A system for making a semiconductor devices by managing a semiconductor device manufacturing process, including an operation of a system having a plurality of sub-modules, comprising:
a module checking part diagnosing an operational state of at least one sub-module of the plural sub-modules;
a process condition checking part diagnosing a process condition of the system;
a result display displaying a diagnosis result of an object, of a plurality of objects of the system, to be diagnosed; and
a controller controlling the module checking part and the process condition checking part to check the operational state of the one sub-module and the process condition of the system prior to beginning the semiconductor device manufacturing process and controlling the display of the result of the diagnosis in the result display.

11. The system for making a semiconductor device according to claim 10, further comprising an interface checking part checking an operational state of an I/O device of the one sub-module, wherein the controller controls the result display to display the result of diagnosis performed by the interface checking part.

12. The system for making a semiconductor device according to claim 10, wherein the controller permits a user to select the object or objects, of the plural objects, to be diagnosed.

13. The system for making a semiconductor device according to claim 12, wherein the user is permitted to select objects not to be diagnosed.

14. A computer-readable medium comprising computer readable code controlling a system to perform the method of claim 1.
